(19) United States
(12) Patent Application Publication
(10) Pub. No.: US 2008/0109566 A1
(43) Pub. Date: May 8, 2008

(54) USB MASS STORAGE DEVICE INTERCONNECT MODULE HAVING AUTOMATIC FILE TRANSFER CAPABILITY AND METHOD OF OPERATION THEREOF

(76) Inventors: David H. Hitt, Plano, TX (US); William C. Montgomery, Rockwall, TX (US)

Correspondence Address: HITT GAINES P.C., P.O. BOX 832570, RICHARDSON, TX, 75083, US

(21) Appl. No.: 11/556,424

(22) Filed: Nov. 3, 2006

(51) Int. Cl. G06F 13/12

(52) U.S. Cl. 710/10

(57) ABSTRACT

A USB mass storage device interconnect module and a method of operating the same to effect an automatic transfer of at least one file between two USB mass storage devices. In one embodiment, the interconnect module includes: (1) a body, (2) first and second USB receptacles recessed into the body, (3) a power source, (4) a USB host controller contained within the body, coupled to the first and second USB receptacles and powered by the power source and (5) a processor contained within the body, coupled to the USB host controller, powered by the power source and configured to initiate an automatic transfer of at least one user file between the first and second USB mass storage devices when the first and second USB mass storage devices are coupled to the first and second USB receptacles.

### TECHNICAL FIELD OF THE INVENTION

The invention is directed, in general, to computer memory peripheral devices and, more particularly, to a Universal Serial Bus (USB) mass storage device interconnect module having automatic file transfer capability and a method of operating the same.

### BACKGROUND OF THE INVENTION

“Pen drives” have become a widely used device for carrying one's computer files about. As is widely known, a pen drive, also called a “memory stick,” “jump drive,” “USB flash drive” (sometimes abbreviated “UFD”), is a solid-state device containing nonvolatile computer memory, typically flash random-access memory (RAM), and a USB port that allows external access to the nonvolatile memory.

To use the pen drive, a user connects the pen drive to a corresponding USB receptacle on a host device, typically a computer. In accordance with the USB standard (which is controlled by the USB Implementers Forum, Inc. (usb.org), the host device automatically detects that a USB device has been connected to it, determines what kind of USB device it is by means of the USB controller and, if the USB device is a pen drive (which it is in this case), treats the pen drive as a logical volume of storage, like a hard disk drive. In this manner, the user can read files from, and write files to, the pen drive.

The beauty of the pen drive is that it can be connected to a host device without having to install a driver for it or reboot the host device, disconnected from the host device without having to reboot the host device and thereafter carry it around, perhaps in one's pocket or briefcase or perhaps suspended from a lanyard about one's neck. Being solid state and packaged in a relatively small, light and durable case, pen drives are reliable, tough and very easy to carry about. For this reason, pen drives have largely displaced floppy disks and even compact disks as portable storage media.

Because the market is so large, quite a number of companies produce pen drives. As a result, pen drives are virtual commodities, with storage capacities increasing and prices decreasing almost daily. This indicates that the popularity of pen drives will continue to increase.

As portable, capacious, durable and easy to use as pen drives now are, they can still benefit from further improvement. What is needed in the art is a device that makes pen drives even more flexible and powerful. Most advantageously, the device should make pen drives more flexible and powerful without diminishing their portability, capacity, durability and ease of use.

### SUMMARY OF THE INVENTION

To address the above-discussed deficiencies of the prior art, the invention provides, in one aspect, a USB mass storage device interconnect module and a method of operating the same to effect an automatic transfer of at least one file between two USB mass storage devices. In one embodiment, the interconnect module includes: (1) a body, (2) first and second USB receptacles recessed into the body, (3) a power source, (4) a USB host controller contained within the body, coupled to the first and second USB receptacles and powered by the power source and (5) a processor contained within the body, coupled to the USB host controller, powered by the power source and configured to initiate an automatic transfer of at least one user file between the first and second USB mass storage devices when the first and second USB mass storage devices are coupled to the first and second USB receptacles.

In another aspect, the invention provides a method of effecting a transfer of data between first and second USB mass storage devices. In one embodiment, the method includes: (1) coupling the first and second USB mass storage devices to a USB mass storage device interconnect module that includes a body, first and second USB receptacles recessed into the body, a power source, a USB host controller contained within the body and powered by the power source and a processor contained within the body and powered by the power source, (2) automatically detecting the coupling and (3) initiating an automatic transfer of at least one user file between the first and second USB mass storage devices upon the automatically detecting.

In yet another aspect, the USB mass storage device interconnect module includes: (1) a body, (2) first and second USB receptacles recessed into the body, (3) a battery contained within the body, (4) a USB host controller contained within the body, coupled to the first and second USB receptacles and powered by the battery, (5) a processor contained within the body, coupled to the USB host controller, powered by the battery and configured and initiate an automatic transfer of at least one user file between the first and second USB mass storage devices when the first and second USB mass storage devices are coupled to the first and second USB receptacles, (6) a program memory coupled to the processor, the automatic transfer occurring in accordance with a control program stored in the program memory, (7) a configuration memory contained within the body and coupled to the processor, the automatic transfer of the at least one user file being based on user-configurable configuration data stored in the configuration memory and (8) an indicator coupled to the body and the processor, powered by the battery and configured to indicate a status of the automatic transfer.

The foregoing has outlined preferred and alternative features of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the invention. Those skilled in the pertinent art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high-level block diagram of one embodiment of a USB mass storage device interconnect module having automatic file transfer capability constructed according to the principles of the invention;

FIG. 2 illustrates a screen shot of a configuration program that may be employed to configure a user-configurable embodiment of the interconnect module of FIG. 1; and

FIG. 3 illustrates a flow diagram of one embodiment of a method of operating a USB mass storage device interconnect module having automatic file transfer capability carried out according to the principles of the invention.

### DETAILED DESCRIPTION

Before describing technical aspects of various embodiments of a novel USB mass storage device interconnect module in detail, its use and possible advantages should be understood in nontechnical, colloquial terms. With an interconnect module as described herein, a user can, for example, transfer user files automatically between or among pen drives (of any type, including conventional pen drives) or other kinds of USB mass storage devices without having to do anything more than plug the two or more drives or devices into the interconnect module. No computer is required to effect the transfer. No buttons need to be pushed; no computer screens need to be read; nothing needs to be plugged into a wall outlet; no email or text messages need to be sent.

This peer-to-peer, automatic file transfer capability is highly advantageous in several real-world contexts. In a work environment, a user can transfer the file(s) containing his business presentation through the interconnect module to those in the audience who want an electronic copy of it. Business-related files can be swapped through the interconnect module at trade shows, airports, seminar ballrooms, golf courses without having to rely on computers or other devices. In an educational environment, a teacher may pass an assignment out by transferring it through the interconnect module to the students' pen drives, and students may in turn transfer their homework or projects from their pen drives through the interconnect module to the teacher's. At a party, people may trade files (such as pictures or homemade audio recordings or videos) with each other as a natural part of their mingling. Those skilled in the pertinent art will understand how advantageous it is to have a USB mass storage device interconnect module that automatically transfers files without the need for further hardware or software and without compromising the portability, light weight, durability and flexibility of the pen drives or the ubiquity and capacity of other types of USB mass storage devices with which it may operate. Those skilled in the pertinent art will also see many applications for the device interconnect of the invention that may not be described herein. All such applications fall within the scope of the invention.

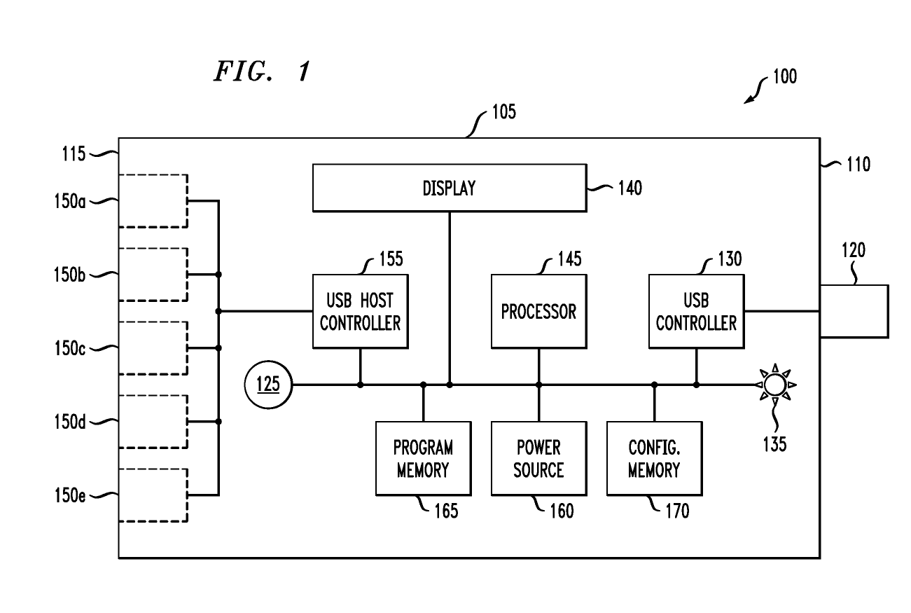

Having described in layman's terms some of possible uses and advantages of the invention, some embodiments will now be described. FIG. 1 illustrates a high-level block diagram of one embodiment of a USB mass storage device interconnect module, generally designated 100 and constructed according to the principles of the invention.

The interconnect module 100 has a tough, rigid, elongated body 105, typically formed of plastic, that serves to support the various components contained within it and is preferably substantially smaller than a laptop computer. In fact, the body 105 may be of such size that it can be readily placed in a shirt or pants pocket, though this need not be the case. The components that make up the interconnect module 100 tend to dictate its overall size.

The illustrated embodiment of the body 105 has a first end 110 and a second end 115. The first end 110 has a USB plug 120 projecting therefrom. The illustrated embodiment employs the USB plug 120 to allow the interconnect module 100 to be coupled to a host device (not shown), which may be a personal computer, to allow the interconnect module 100 to be configured. In the illustrated embodiment, the USB plug 120 is a Type A USB plug; however, the USB plug 120, if present, may be of any Type.

A USB controller 130 is coupled to the USB plug 120. Together, the USB controller 130 and the USB plug 120 are regarded as a USB port. As those skilled in the pertinent art understand, the USB controller 130 is configured to communicate through the USB plug 120 to establish a logical connection with a hosting device (not shown), such as a computer. During the establishment of that logical connection, the USB controller 130 communicates information regarding the interconnect module 100 such that the hosting device may understand its needs and capabilities.

An indicator lamp 135 is coupled to the body 105 such that it can be viewed from outside of the body 105. In the illustrated embodiment, the indicator lamp 135 is a light-emitting diode (LED). However, this need not be the case.

A processor 145 is coupled to the USB controller 130 and is configured to function in a variety of ways that will be described below. The processor 145 may be a microprocessor, microcontroller, digital signal processor (DSP) or any other kind of processor having sufficient capability to provide the functions desired of the processor 145. Further, the processor 145 may be separate from other components of the interconnect module 100 or integrated with one or more of those components. For example, the processor 145 may be integrated with a USB controller (e.g., the USB controller 130), if that controller has sufficient capability to provide the functions desired of the processor 145.

A plurality of (five, in the illustrated embodiment) USB receptacles 150a-e are recessed into the second end 115. The USB receptacles 150a-e are configured to receive two or more pen drives (not shown) to allow data transfer therebetween or thereamong in various ways, some of which will be described below. The USB receptacles 150a-e may be Type A USB receptacles. The USB receptacles 150a-e may be of the same USB Type (Type A, Type B, etc.) as the USB plug 120, or they may be of a different Type. Each of the USB receptacles 150a-e may include various Types to accommodate different USB devices having plugs of various Types. Further, the USB receptacles 150a-e need not be located proximate the second end 115. Instead, the USB receptacles 150a-e (and, for that matter, the USB plug 120) may recess into or project from any part of the body 105.

A USB host controller 155 is coupled to the USB receptacles 150a-e and the processor 145. Together, the USB host controller 155 and the USB receptacles 150a-e may be regarded as a set of USB ports. As those skilled in the pertinent art understand, the USB host controller 155 is configured to communicate through the USB receptacles 150a-e to establish a logical connection with a hosted device (not shown in FIG. 1), such as a USB mass storage device (e.g., a pen drive). During the establishment of that logical connection, the USB host controller 155 provides power to the hosted device, requests information regarding the hosted device such that the interconnect module 100 may understand its storage and/or data transfer capabilities and communicates with the hosted device in accordance with that information.

As previously stated, the USB host controller 155 provides power to the hosted device. Accordingly, the interconnect module 100 includes a power source 160, advantageously located within the body 105. In the embodiment of FIG. 1, the power source 160 includes, and in fact may be, a battery, perhaps of the lithium-ion type, and perhaps accessible via a door (not shown) in the body 150 such that it can be replaced as needed.

Two components that may assist the processor 145 in providing its desired functions will now be described. A program memory 165 is coupled to the processor 145 and contains a control program that controls operation of the processor 145, to cause, for example, the transfer of at least one file between or among hosted devices coupled to the interconnect module 100. Certain functions that the processor 145 may perform will be described herein, with the understanding that many possible functions are possible without departing from the invention.

The program memory 165 may be quite small in terms of its storage capacity (perhaps on the order of kilobytes, or KB). In the embodiment of FIG. 1, the program memory 165 is read-only memory (ROM). In one embodiment, the program memory 165 is externally addressable and contains a configuration program in addition to the control program that controls operation of the processor 145. An exemplary configuration program will be described below, with the understanding that many possible configurations are possible without departing from the invention.

A configuration memory 170 is likewise coupled to the processor 145. The configuration memory 170 contains configuration data that, in conjunction with the control program, controls the operation of the processor 145. The configuration memory of FIG. 1 is extremely small, on the order of one KB or less, since the functions that the processor 145 is to perform in the illustrated embodiments are limited and of limited variation. The configuration data may be factory-preset or user-configurable via, e.g., the configuration program.

The program memory 165 and configuration memory 170 may be embedded with the processor 145 on a single integrated circuit (IC) chip or may be separate ICs. In fact, many of the components of the interconnect module 100 may be integrated into a single, application-specific IC (ASIC) for compactness and ease of assembly.

Though the embodiment of FIG. 1 is relatively simple, more complex embodiments fall within the scope of the invention. For example, the interconnect module 100 may advantageously be provided with one or more user-operable buttons (e.g., a button 125) to allow, for example, the user manually to initiate or terminate a file transfer, to control the direction of the file transfer, to control the routing of the file transfer or to control the files or folders transferred.

The interconnect module 100 may advantageously be provided with a display 140, perhaps a liquid crystal display (LCD), allowing menus and status data to be displayed and perhaps allowing user decisions to be based thereon. With a display, the indicator lamp 135 may no longer be necessary. The interconnect module 100 may be provided with a vibrator or a speaker (not shown), which would provide other means of informing a user about a file transfer.

Having described some embodiments of the interconnect module 100, various possible modes of operation will now be described. In a host mode, two or more hosted devices (not shown) are coupled to ones of the USB receptacles 150a-e. For example, a first hosted mass storage device (e.g., a pen drive) may be coupled to the USB receptacle 150a (a “first USB receptacle 150a”), and a second hosted mass storage device (e.g., a pen drive) may be coupled to the USB receptacle 150b (a “second USB receptacle 150b”) of the interconnect module 100. In response, the USB host controller 155 automatically provides power to the first and second hosted mass storage devices and requests and receives information regarding the first and second hosted mass storage devices such that the interconnect module 100 may understand their storage and data transfer capabilities. Thereafter, and preferably automatically, the processor 145 initiates a transfer of at least one user file (files, folders or other data of interest to a user) between the first and second hosted mass storage devices.

The transfer may be a transfer from the first hosted mass storage device to the second hosted mass storage device, a transfer from the second hosted mass storage device to the first hosted mass storage device, or both. The interconnect module 100 may be provided with its own nonvolatile memory (not shown), in which case the transfer may be to or from that nonvolatile memory. If more than two hosted mass storage devices are coupled to the interconnect module 100, the transfer may effect a distribution of one or more files or folders from one of the hosted mass storage devices to the other ones, perhaps concurrently to save time.

During the transfer, the indicator lamp 135 may blink, or the to prompt the user to keep the hosted memory device 200 and the interconnect module 100 coupled together until the transfer is complete. Following the transfer, the indicator lamp may turn off or remain constantly on. In an embodiment to be described, a user can configure the operation of the indicator lamp.

In a pass-through mode, the interconnect module 100 is coupled to a host device and further to one or more hosted devices, which may or may not be USB mass storage devices. The interconnect module 100 may serve as a logical volume of storage for the host device if the interconnect module contains nonvolatile memory or the configuration program and further allows the hosted mass storage device to serve as a logical volume of storage for the host device. The pass-through mode, at least with respect to the illustrated embodiment, acts as a conventional USB hub and therefore provides a USB port-saving or port-expanding feature by which a single USB port on the host device can support at least two USB devices.

In the pass-through mode, the user may perform file transfers using the host device. Further, it is assumed that the host device provides power for both the interconnect module 100 and the hosted mass storage device; the power source 160 of the interconnect module 100 is therefore spared the duty. A user may be able selectively to activate the pass-through mode via a configuration setting.

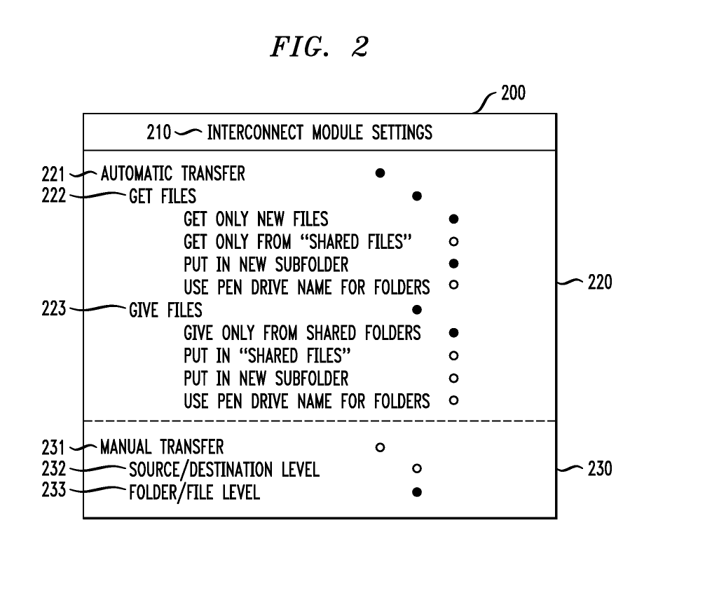

In several embodiments, the interconnect module 100 further includes a configuration program executable on a host device to allow a user to configure the configuration data contained in the configuration memory 170. FIG. 2 illustrates a screen shot 200 of a rudimentary configuration program that may be employed to configure a user-configurable embodiment of the interconnect module 100.

Before describing the screen shot 200, it should be noted that the configuration program could be provided on a disk sold with the interconnect module 100 or, more advantageously, stored in the interconnect module 100, e.g., in the program memory 165 of FIG. 1. In the latter case, the configuration program might appear as an executable (e.g., .com or .exe) file in the interconnect module when the interconnect module is coupled to the host device. The configuration program can then be executed off the interconnect module without the need for a separate disk.

Turning now to the screen shot 200, under a title 210, is a list of possible configuration settings (not separately referenced). The user can select or deselect configuration settings by blackening or whitening bullets (also not separately referenced) located next to each of the configuration settings as shown. Those skilled in the art know that the spacebar or a mouse click can be used for blackening and whitening bullets.

The configuration settings illustrated in FIG. 2 will be described with the understanding that they are merely examples of possible interconnect module functions. More or fewer configuration settings may be desired, depending upon how sophisticated or simple the interconnect module functions are to be for a given embodiment. The configuration settings are grouped into two groups: an AUTOMATIC TRANSFER group 220 and a MANUAL TRANSFER group 230.

For purposes of automatic transfers, it will be assumed that two of the USB receptacles, e.g., the first and second USB receptacles 150a, 150b are predesignated for automatic transfer. For example, the first USB receptacle 150a may be predesignated to receive a first mass storage device that is to be a “source,” and the second USB receptacle 150b may be predesignated to receive a second mass storage device that is to be a “destination.” Manual transfers to not require such predesignation, as a user can designate source and destination USB mass storage devices, folders and files as necessary using, e.g., the display 140 of FIG. 1.

In the AUTOMATIC TRANSFER group 220, a user can first select (via a configuration setting 221) whether or not any automatic file transfer should take place. If the user does not want any automatic file transfers to take place, the bullet next to the configuration setting 221 should be whitened; otherwise it should be blackened.

Assuming, as shown, that the user wants automatic file transfers to take place, he now can select (via a configuration setting 222) whether transfers from the source USB mass storage device to the destination USB mass storage device (“GETs”) should take place. Assuming, as shown, that the user does want GETs to take place, the user may then, via unreferenced settings under the configuration setting 222, designate what files and how they should be stored. The user can select whether the destination USB mass storage device should get only files that do not already exist on the destination USB mass storage device (“new files”) or all files irrespective of their pre-existence on it. Then the user can select whether the destination USB mass storage device should get files only from a folder on the source USB mass storage device named “Shared Files.” This allows users to define a “Shared Files” folder on their, USB mass storage devices, e.g., pen drives, from which files are shared. If that configuration setting is whitened, all files are transferred from the source USB mass storage device, irrespective of the folder in which they may be contained.

Then the user can decide how to store the files on the destination USB mass storage device. The user can select whether a new subfolder should be created for the files or whether the files should be stored in the destination USB mass storage device's root folder. The former allows files to be grouped by origin, making it easier to determine from whom a file was received. The latter results in a simpler folder structure. If the former is selected, the user can then select how to name the newly-created folders. Being a USB device, the source USB mass storage device (called “pen drive” in the screen shot 200) has a logical name that it provides. That name can be used as the folder name, or a unique name may be assigned to the folder based upon some convention, perhaps an incrementing number. As is apparent from FIG. 2, the user wants the interconnect module to transfer only new files and put them in a folder that is assigned a unique name based upon some convention.

One or more folders and/or files may also be transferred from the destination USB mass storage device to the source USB mass storage device (“GIVEs”). A user can first select (via a configuration setting 223) whether or not the interconnect module should transfer any files from the destination USB mass storage device to the source USB mass storage device. If the user does not want the source USB mass storage device to receive any files, the bullet next to the configuration setting 223 should be whitened; otherwise it should be blackened. Assuming, as shown, that the user wants GIVEs to take place, the user can, via unreferenced settings under the configuration setting 222, select what files and how they should be stored on the hosted memory device. The user can select whether the destination USB mass storage device should give only files from folders that have a “shared” permission, such as one named “Shared Files.” Those skilled in the pertinent art are aware that modern operating systems, such as Microsoft® Windows® XP®, allow folders to be shared by setting a “shared” permission to those folders.

Then the user can decide how to store the received files on the source USB mass storage device. The user can select whether the interconnect module should put the files in a folder on the source USB mass storage device named “Shared Files,” creating such a folder if it does not already exist. If not, files are put in the root folder of the source USB mass storage device. Alternatively, the user can select whether a new subfolder should be created for the files. If the latter is selected, the user can then select how to name the newly-created folders. The destination USB mass storage device's logical name can be used as the folder name, or the interconnect module can assign a unique name to the folder based upon some convention. As is apparent from FIG. 2, the user wants the destination USB mass storage device to give files only from shared folders and put them in the root folder of the source USB mass storage device.

In the MANUAL TRANSFER 230, the user can select (via a configuration setting 231) whether manual transfers should be allowed. If not, the interconnect module performs file transfers entirely automatically, which is simple and appropriate under some circumstances. If not, the user may control the transfer process via buttons (e.g., the button 125 of FIG. 1) and the screen 140 of FIG. 1.

Upon exiting the configuration program, the configuration program saves the configuration settings to the configuration memory 170 of FIG. 1, overwriting previous, perhaps factory, configuration settings.

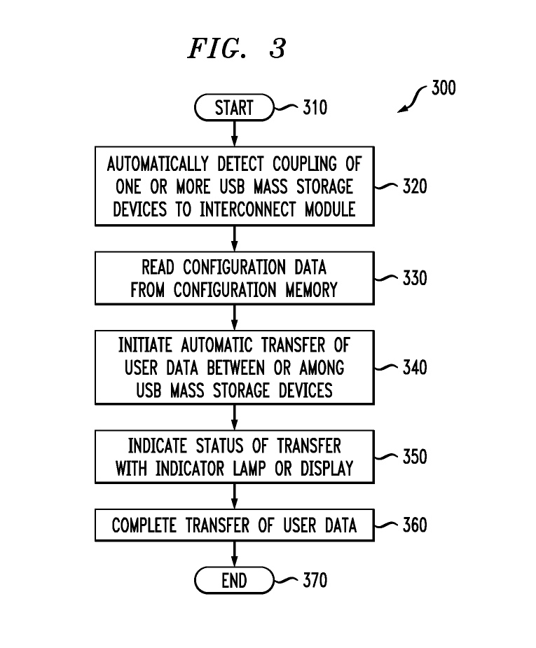

Turning now to FIG. 3, illustrated is a flow diagram of one embodiment of a method 300 of operating a USB mass storage device interconnect module having automatic file transfer capability carried out according to the principles of the invention. The method begins in a start step 310.

In a step 320, one or more USB mass storage devices are coupled to the interconnect module, at which time the one or more USB mass storage devices are automatically recognized in accordance with USB standards. In a step 330, the control program is automatically invoked to cause the processor to read the configuration data from the configuration memory. In a step 340, the control program causes the processor to initiate an automatic transfer of at least one user file between or among the USB mass storage devices (via the USB host controller) and perhaps a nonvolatile main memory of the interconnect module in accordance with the configuration data.

In a step 350, the control program causes the processor to indicate the status of the transfer by way of the indicator lamp, the display or both. In a step 360, the transfer of at least one user file is completed, and the control program again causes the processor to indicate the status of the transfer by way of the indicator lamp, the display or both. The method ends in an end step 370.

Although the invention has been described in detail, those skilled in the pertinent art should understand that they can make various changes, substitutions and alterations herein without departing from the scope of the invention in its broadest form.

What is claimed is:

1. A USB mass storage device interconnect module, comprising:
a body;
first and second Universal Serial Bus (USB) receptacles recessed into said body;
a power source;
a USB host controller contained within said body, coupled to said first and second USB receptacles and powered by said power source; and
a processor contained within said body, coupled to said USB host controller, powered by said power source and configured to initiate an automatic transfer of at least one user file between said first and second USB mass storage devices when said first and second USB mass storage devices are coupled to said first and second USB receptacles.

2. The interconnect module as recited in claim 1 wherein said first and second USB receptacles are of the same USB Type.

3. The interconnect module as recited in claim 2 wherein said first and second USB receptacles are Type A USB receptacles.

4. The interconnect module as recited in claim 1 wherein said power source comprises a battery contained within said body.

5. The interconnect module as recited in claim 1 further comprising an indicator lamp coupled to said body and said processor.

6. The interconnect module as recited in claim 1 further comprising a program memory coupled to said processor, said automatic transfer of said at least one user file occurring in accordance with a control program stored in said program memory.

7. The interconnect module as recited in claim 6 wherein said program memory is read-only memory.

8. The interconnect module as recited in claim 1 further comprising a configuration memory contained within said body and coupled to said processor, said automatic transfer of said at least one user file being based on configuration data stored in said configuration memory.

9. The interconnect module as recited in claim 8 wherein said configuration data is user-configurable.

10. The interconnect module as recited in claim 9 further comprising a button coupled to said body and said processor and employable to allow a user to configure said configuration data.

11. The interconnect module as recited in claim 9 further comprising a configuration program executable on a host device configured to host said interconnect module to allow a user to configure said configuration data.

12. The interconnect module as recited in claim 1 further comprising a liquid crystal display coupled to said processor.

13. The interconnect module as recited in claim 1 wherein at least one of said first and second USB mass storage devices is a pen drive.

14. A method of effecting a transfer of data between first and second USB mass storage devices, comprising:
coupling said first and second USB mass storage devices to a USB mass storage device interconnect module that includes a body, first and second Universal Serial Bus (USB) receptacles recessed into said body, a power source, a USB host controller contained within said body and powered by said power source and a processor contained within said body and powered by said power source;
automatically detecting said coupling; and
initiating an automatic transfer of at least one user file between said first and second USB mass storage devices upon said automatically detecting.

15. The method as recited in claim 14 wherein said first and second USB receptacles are of the same USB Type.

16. The method as recited in claim 15 wherein said first and second USB receptacles are Type A USB receptacles.

17. The method as recited in claim 14 wherein said power source comprises a battery contained within said body.

18. The method as recited in claim 14 wherein said USB mass storage device interconnect module further includes an indicator lamp coupled to said body.

19. The method as recited in claim 14 wherein said USB mass storage device interconnect module further includes a program memory, said initiating occurring in accordance with a control program stored in said program memory.

20. The method as recited in claim 19 wherein said program memory is read-only memory.

21. The method as recited in claim 14 wherein said USB mass storage device interconnect module further includes a configuration memory contained within said body and coupled to said processor, said initiating being based on configuration data stored in said configuration memory.

22. The method as recited in claim 21 wherein said configuration data is user-configurable.

23. The method as recited in claim 22 wherein said USB mass storage device interconnect module further includes a button coupled to said body, said method comprising allowing a user to employ said button to configure said configuration data.

24. The method as recited in claim 22 further comprising executing a configuration program on a host device configured to host said interconnect module, said method comprising allowing a user to configure said configuration data.

25. The method as recited in claim 14 wherein said USB mass storage device interconnect module further includes a liquid crystal display.

26. The method as recited in claim 14 wherein at least one of said first and second USB mass storage devices is a pen drive.

27. A USB mass storage device interconnect module, comprising:
a body;
first and second Universal Serial Bus (USB) receptacles recessed into said body;
a battery contained within said body;
a USB host controller contained within said body, coupled to said first and second USB receptacles and powered by said battery;
a processor contained within said body, coupled to said USB host controller, powered by said battery and configured to initiate an automatic transfer of at least one user file between said first and second USB mass storage devices when said first and second USB mass storage devices are coupled to said first and second USB receptacles;
a program memory coupled to said processor, said automatic transfer occurring in accordance with a control program stored in said program memory;
a configuration memory contained within said body and coupled to said processor, said automatic transfer of said at least one user file being based on user-configurable configuration data stored in said configuration memory; and
an indicator coupled to said body and said processor, powered by said battery and configured to indicate a status of said automatic transfer.

28. The interconnect module as recited in claim 27 wherein said indicator is selected from the group consisting of:
an indicator lamp, and
a liquid crystal display.

29. The interconnect module as recited in claim 27 wherein said program memory is read-only memory.

30. The interconnect module as recited in claim 27 further comprising a button coupled to said body and said processor and employable to allow a user to configure said configuration data.

31. The interconnect module as recited in claim 27 further comprising a configuration program executable on a host device configured to host said interconnect module to allow a user to configure said configuration data.

32. The interconnect module as recited in claim 27 wherein at least one of said first and second USB mass storage devices is a pen drive.
